(19) United States
(12) Patent Application Publication
(10) Pub. No.: US 2002/0114965 A1
(43) Pub. Date: Aug. 22, 2002

(54) Co-extruded pigmented/clear coated polymeric coating for automotive exterior body panels

(76) Inventor: John Horansky, Troy, MI (US)

Correspondence Address: Lawrence J Shurupoff, DaimlerChrysler Intellectual Capital Corporation, CIMS 483-02-19, 800 Chrysler Drive, Auburn Hills, MI, 48326-2757, US

(21) Appl. No.: 09/785,407

(22) Filed: Feb. 16, 2001

(51) Int. Cl. B32B 27/30

(52) U.S. Cl. 428/520; 264/173.18

(57) ABSTRACT

A coating for an exterior surface of an automotive vehicle body panel is provided including a first layer of an ionomer polymeric coating material with a transparent base which has been pigmented to a desired color and extruded, a second layer of transparent ionomer polymeric coating material which has been co-extruded with the first layer and a third layer of polymeric coating material co-extruded with the first layer opposite the second layer, the third layer being more opaque than the first layer.

### FIELD OF THE PRESENT INVENTION

The present invention relates to a multi-layer polymeric coating for automotive exterior body panels. More particularly, the present invention in its most elementary form relates to a co-extruded polymeric coating for automotive exterior body panels having a layer of the co-extrusion pigmented for color and another layer of polymeric coating to provide a clear coat.

### BACKGROUND OF THE INVENTION

Several technical trends have developed in the past two decades to achieve increased fuel economy of automotive vehicles. One such trend is to decrease the weight of the vehicle. When a vehicle is traveling at highway speeds, up to one-half of the force needed to propel the vehicle forward is due to the aerodynamic drag of the vehicle rather than the vehicle weight. Therefore, if the aerodynamic drag of a vehicle can be lessened, a significant increase in fuel economy can be achieved.

To achieve the above-noted technical trends of weight reduction and the lowering of aerodynamic drag a new type of bumper has been developed. The new type of bumper, often referred to as a fascia, is fabricated from a polymeric material which is lighter than most metals. Prior bumpers were steel and extended outward from the remainder of the car body. Fascias are typically formed in rounded shapes that blend into the contour of the remainder of the vehicle body. The shape of the fascia lowers aerodynamic drag of the vehicle. Additionally, the fascia can materially add to the styling enhancement of the vehicle. Yet another advantage of the fascia is that its color can be selected to match the color of the remainder of the car body.

A so-called clear coat technique (sometimes referred to as two-coat one-bake technique) is used to cover metal body panels of most cars and light trucks. The clear coat technique comprises applying a metallic base paint composition, called a top coat, containing an optional metallic pigment, to a steel substrate. The steel substrate is provided in advance with undercoat and intermediate coat primers. Then, without curing the resulting top coat paint film, a clear paint composition is applied over the top coat in a wet-on-wet manner. The top coat and clear paint are then cured simultaneously.

Prior to the present invention, most fascias were injection molded. The molded fascias were then painted with a color coat to match the paint on the metal vehicle body. A second clear coat of paint was then applied to the fascia so that the appearance of the fascia would match that of the remainder of the vehicle body. The color utilized to paint the fascia sometimes had to be modified because the resultant color of cured paint on the injection molded fascia sometimes would differ from the color of the paint on a steel substrate. Therefore, trial and error was required to get the colors on the fascia to match the color of the remainder of the car body.

A prior method to cover the facia substrate included using a painted polymeric sheet of material. A clear coat of material was laminated to the painted sheet by a spray, dip coating or adhesive technique. Additional layers of material may have been added for processing or to add strength. The polymeric sheet was then shrink wrapped over a premolded polymeric substrate.

In another prior method, the color imparted to the sheet material by a pigment application rather than a painted application. The top clear coat was added as in the previously described method. Both methods often resulted in delamination during the shrink wrap process when the sheet material was bent as it was formed to cover the curved fascia.

It is desirable to provide a covering sheet for an automotive vehicle body panel, especially a bumper fascia, which has a top coat/clear coat appearance and which can be formed into complex shapes without suffering delamination. Specifically, it is desirable to provide a coating for a fascia or similar body panel which is readily color matched to another colored automotive vehicle body panel.

### SUMMARY OF THE INVENTION

To make manifest the above-noted and other unfulfilled desires, the present invention is brought forth. In one preferred embodiment, the sheet material used as a coating includes a first polymeric clear layer, preferably an ionomer. The first layer is developed from a transparent base which has been pigmented to a desired color and the first layer is extruded. A second layer of polymeric material, preferably an ionomer, is coextruded with the first layer and engaging one side of the first layer. The second layer is semitransparent and typically will have a thickness which is generally a fraction of that of the pigmented first layer. A third opaque layer can also be provided. The third layer is co-extruded with the first layer and engages the second side of the first layer opposite the first side. The third layer is typically a polymer that is compatible with the ionomer material and a polymeric substrate which forms a panel or facia that the covering is placed over. In some applications the third layer will be opaque ethylene or polypropylene. The third layer is pigmented like the first layer but made more opaque The third layer may be either an off or an on color with respect to the color imparted to the first layer depending on the particular desired final color of the multi-layer assembly.

The third layer is provided for several purposes, one of which is to prevent visual bleed-through from the substrate that the coating is applied to. Secondly, the third layer has added compatibilizers to allow the substrate to be molded behind the coating. Thirdly, the substrate can have an adhesive layer on its inward exposed surface to allow it to be adhesively connected to the molded substrate. Fourthly, it can be used (via pigments) to supplement a color of the first semitransparent layer. The coating can be vacuum formed over a premolded metallic or polymeric body panel or in an alternative embodiment, the coating can be placed within a mold and a polymeric substrate can be injection molded behind it.

Accurate color matching of a panel with an extruded colored coating to other vehicle panels is important. Further, color matching is necessary both when viewing a coated panel straight-on (at a 90 degree angle) and when viewing the coated panel obliquely or flopped so the viewing angle is at another angle. The subject coating application relies on a semitransparent first layer to provide primary color match when the coated part is viewed straight-on and partially when the coated part is viewed at an angle or flopped. In addition, the third layer is utilized for additional color influence of the multilayer assembly for both normal viewing and for flop. The pigment loading and the thickness of the third layer effects the chromaticity of the colored part. For metalic colors, the transparancy of the second layer maximizes the the effect of metalics. The third layer's degree of pigment loading and degree of opaqueness effect the hiding power of the coated part. This also controls light penetration and tends to minimize color loss after the coating is formed about the substrate.

As rays of white light pass through the second clear coat layer, a portion of the rays strike pigment particles. Consequently, certain wave lengths of the white light are absorbed. The rest of the wave lengths of the white light characteristic of the desired color produced by the pigment are reflected back through the coating to the surface of the second layer. At the same time, other rays of the white light which do not strike pigment particles penitate deeper into the semitransparent first layer and perhaps stike a deep down pigment particle. Depending on the thickness of the semitransparant layer, most of the light rays strike a pigment particle. Light penitatration is stopped at the opaque third layer but light rays striking the pigment carried by the third layer is reflected back to the surface. No light rays are able to penetrate past the third layer and therefore the substrate cannot effect the effective color of the multilayer assembly.

The above-noted and other objects of the present invention will become apparent to those skilled in the art from a review of the invention as it is provided in the accompanying drawings and detailed description of the preferred embodiment.

### BRIEF DESCRIPTION OF THE DRAWINGS

FIG. 1 is an enlarged side elevational view of an automotive vehicle body panel color coating membrane sheet according to the present invention.

FIG. 2 is a schematic view of the extruders utilized to produce the automotive vehicle body panel color coating according to the present invention.

FIG. 3 is a side sectional view of an exterior body panel utilizing the color coating of the present invention having a metallic self-supporting member.

FIG. 4 is a view similar to that of FIG. 3 illustrating an embodiment of the present invention with a body panel having a polymeric substrate self-supporting member.

### DETAILED DESCRIPTION OF THE PREFERRED EMBODIMENT

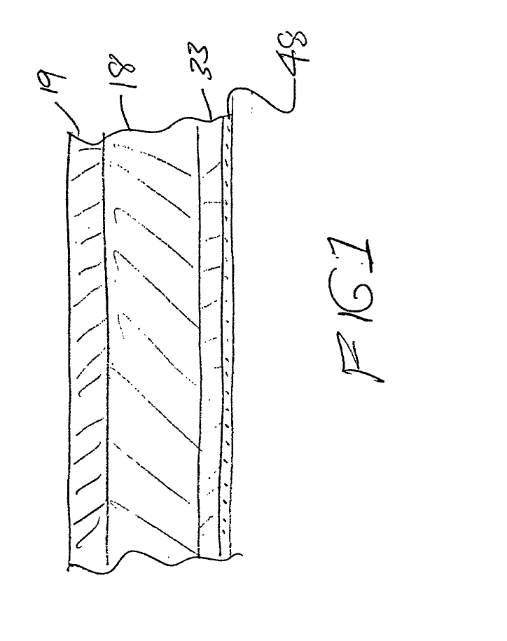

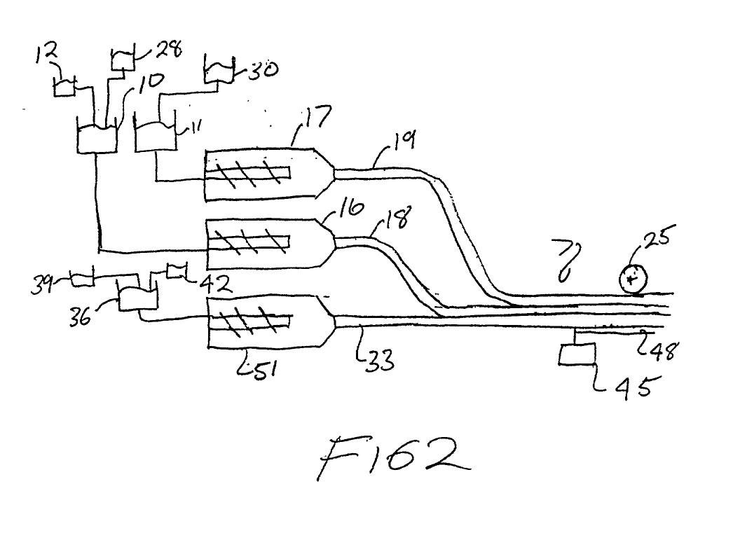

Referring to FIGS. 1-2, a first material mixing tank 10 is provided to contain a first material supply. The first material mixing tank 10 contains a polymeric material, typically an ionomer, although other suitable materials may be utilized. Typical ionomers are manufactured or blended by DuPont, Exxon and A. Shulman. The ionomer in the first material tank 10 has a clear transparent base. The transparent base material is pigmented to a desired color. A tank 12 supplies the pigment to the first material supply. The pigment is color matched to match the color of the base coat which is used on the remainder of the car body. From the first material mixing tank 10, the ionomer is delivered to a screw barrel extruder 16 which extrudes the first pigmented material at approximately 420 degrees Fahrenheit. A thickness of first layer 18 of the co-extrusion color coating 7 will typically range from 0.006 inches to 0.012 inches. A feeder tank 28 provides reflective flakes and pigments to the first material tank 10. The reflective flakes are made from aluminum, mica, or other suitable material and provide the coating 7 with a reflective appearance. The extrusion process of the extruder 16 orients and aligns the reflective flakes to allow their top surface to provide maximum reflectivity.

A second ionomer material tank 11 is provided. The second ionomer tank 11 contains a similar or identical ionomer material to that of the first material tank 10 which has a clear transparent base. The second material is extruded at a similar temperature into a second layer 19 by a barrel extruder 17. The thickness of the second layer 19 is between 0.005 to 0.010 inches. If desired, a suitable pigment can be supplied to the second ionomer material tank 11 by a tank 30 to give a slight tint to the second layer 19. The tint may be provided to make a slight adjustment to the color (of the cover 7).

A temperature controller is provided to smooth out the top surface of the first layer 18. If the coating 7 is of a two-layer variety, acceptable in some applications, compatibilizers can be added to the first layer 18 to allow it to adhere to an injection molded substrate.

The coating 7 also has a third layer 33. A tank 36 holds the third polymeric material. The third material in tank 36 is fed to an extruder 51 which extrudes it into the aforementioned third layer 33. The third polymeric material is compatible with the first material and any polymeric substrate covered by coating 7. In some applications the third material can be ethylene or polypropylene blended with compatibilizers. The third polymeric material is typically more opaque than the first material 18. Tank 39 will pigment the third material 33 to be more opaque than the first material 18 and to be either an on or off color with respect to the layer 18 depending on the desired final color. In other applications, the base material itself is opaque. Tank 42 will optionally provide a compatibilizer(s) to the third material tank 36 in instances where an injected substrate will be used behind the coating 7.

A typical thickness for the third material 33 will be 0.010 to 0.015 inches. To the underside of the third layer 33 there can be applied an adhesive layer 48 to allow the coating 7 to be adhesively joined to an underlying substrate.

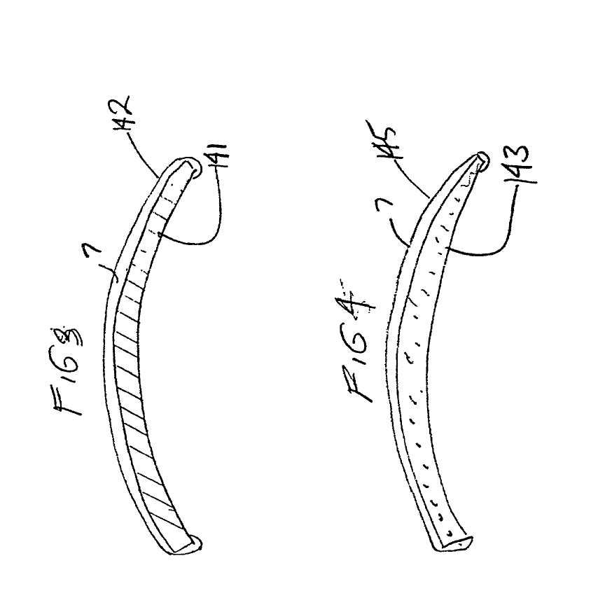

Referring to FIG. 3, a body panel 142 is shown utilizing a coating 7 according to the present invention. The body panel includes a self-supporting, plastic or fiberglass reinforced polymer 141. The coating 7 is vacuum formed and injection molded polymer is then shot on the back side of the coating.

In a similar manner as best shown in FIG. 4, a polymeric substrate injection formed member 43 which can be plastic or plastic reinforced by fiberglass or other suitable filament, has an adjacent coating 7 forming its skin.

A major advantage of the present invention is that panels 142 and 145 (FIGS. 3-4) can be utilized on a vehicle together or separately without worrying about the matching of the paint on the remainder of the vehicle body panels. Prior to the present invention, if a polymeric substrate self-supporting member such as member 143 were placed on a nonmetallic substrate, the paint on the substrate would have to be adjusted in color to match the paint on the remaining metallic exterior vehicle body panels. However, since the third layer 33 of the coating 7 is opaque in the subject application, the only concern is that the pigmentation on the second layer 19 and the third layer (partial) matches that on the clear coat body. As previously mentioned, in some applications, it may be desirable to slightly tint the second layer 19 to help match the color of the remainder of the car body or to inhibit discoloration due to exposure to the environment over time.

The present inventive automotive vehicle body panel polymeric coating has been shown in a preferred embodiment. However, it will be apparent to those skilled in the art that various modifications can be made to the present invention without departing from the spirit or scope of the present invention as it is encompassed in the specification and drawings and by the following claims. For example, the polymeric coating may be applied to virtually any suitable substrate such as airplanes, ships, building structures, and other manufacturing components.

I claim,

1. A coating for an exterior surface of an automotive vehicle body panel comprising:
a first layer of polymeric coating material with a transparent base which has been pigmented to a desired color before being extruded resulting in a semitransparent layer;
a transparent second layer of polymeric coating material with a transparent base which is co-extruded with said first layer.

2. A coating for an exterior surface of an automotive vehicle body panel as described in claim 1, having a third layer of polymeric coating material which is co-extruded with said first layer, said third layer being more opaque than said first layer.

3. A coating for an exterior surface of an automotive vehicle body panel as described in claim 2, wherein said third layer has an opaque base.

4. A coating for an exterior surface of an automotive vehicle body panel as described in claim 2, wherein said third layer has an off color from the color of said first layer.

5. A coating for an exterior surface of an automotive vehicle body panel as described in claim 2, wherein said third layer has an on color from the color of said first layer.

6. A coating for an exterior surface of an automotive vehicle body panel as described in claim 1, wherein said first and second layers are ionomers.

7. A coating for an exterior surface of an automotive vehicle body panel as described in claim 1, wherein said first and second layers are transparent.

8. A coating for an exterior surface of an automotive vehicle body panel as described in claim 1, wherein said second layer is tinted to modify the appearance of said first layer as seen through said second layer.

9. A coating for an exterior surface of an automotive vehicle body panel comprising:
a first layer of ionomer polymeric coating material with a transparent base which has been pigmented to a desired color and extruded;
a second layer of transparent ionomer polymeric coating material which has been co-extruded with said first layer having a thickness less than that of said first layer;
a third layer of polymeric coating material co-extruded with said first layer opposite said second layer, said third layer being more opaque than said second layer.

10. A method of producing a coating for an exterior surface of an automotive vehicle body panel as described in claim 17 additionally comprising:
co-extruding a third supply of a polymeric base coating onto said first supply of polymeric coating opposite said second supply of polymeric coating, said third supply of polymeric coating being more opaque than said first supply of polymeric coating.

11. An exterior body panel for an automotive vehicle part comprising:
a body structure;
a color coating joined to said body structure, said coating including;
a first layer of polymeric material with a transparent base which has been pigmented to a desired color and then having been extruded; and
a second layer of polymeric material with a transparent base which is co-extruded with said first layer.

12. An exterior body panel for an automotive vehicle body as described in claim 11, wherein said color coating additionally has a third layer of polymeric material which is more opaque than said first layer of polymeric material, said third layer of polymeric material being co-extruded with said first layer of polymeric material generally opposite said second layer of polymeric material.

13. An exterior body panel for an automotive vehicle body as described in claim 11, wherein said body structure is a polymeric preform.

14. An exterior body panel for an automotive vehicle body as described in claim 11, wherein said body structure is fabricated from said polymeric material which has been injection molded adjacent to said coating adjacent said first layer.

15. An exterior body panel for an automotive vehicle body as described in claim 12, wherein said body structure is fabricated from said polymeric material which has been injection molded adjacent to said coating adjacent said third layer.

16. A coating for an exterior surface of an automotive vehicle body comprising:
a first layer of polymeric coating material with a transparent base which has been pigmented to a desired color before being extruded;
metallic reflective flakes positioned within said extruded first layer of polymeric coating material; and
a transparent second layer of polymeric coating material with a transparent base which is co-extruded with said first layer.

17. A coating for an exterior surface of an automotive vehicle body as described in claim 16, additionally comprising:
a third layer of polymeric material co-extruded with said first layer of polymeric coating material being generally more opaque than said first layer and being co-extruded to said first layer generally opposite said second layer of polymeric coating material.

18. A method of producing a coating for an exterior surface of an automotive vehicle body panel having reflective flakes comprising:
pigmenting a first supply of clear base polymeric material to a desired color while adding reflective metallic flakes to the first supply of polymeric coating material;
extruding the first supply of polymeric coating material into a first layer; and
co-extruding a second supply of transparent clear base polymeric coating with said first layer.

19. A method of producing a coating for an exterior surface of an automotive vehicle body panel as described in claim 18, further including co-extruding a third supply of polymeric material with said first layer generally opposite said second layer, said third layer being more opaque than said first layer of polymeric material.
